(19) United States
(12) Patent Application Publication
(10) Pub. No.: US 2023/0192736 A1
(43) Pub. Date: Jun. 22, 2023

(54) ORGANOMETALLIC COMPOUNDS

(71) Applicant: UMICORE AG & CO. KG, Hanau-Wolfgang (DE)

(72) Inventors: Nicholas RAU, Marburg (DE); Annika FREY, Hanau (DE); Ralf KARCH, Kleinostheim (DE); Eileen WOERNER, Nidderau (DE); Angelino DOPPIU, Seligenstadt (DE)

(73) Assignee: UMICORE AG & CO. KG, Hanau-Wolfgang (DE)

(21) Appl. No.: 17/995,153

(22) PCT Filed: Apr. 1, 2020
(86) PCT No.: PCT/EP2020/059264

§ 371 Date: Sep. 30, 2022

(51) Int. Cl. C07F 11/00

(52) U.S. Cl. CPC C07F 11/005

(57) ABSTRACT

The invention relates to a one-pot method for preparing oxido (tetraalkoxido) tungsten compounds according to the general formula [W(O)(OR)₄] (I), originating from WCl₆, hexamethyldisiloxane, an alcohol ROH and an amine or NH₃ gas. The invention further relates to the use of a compounds [W(O)(OR)₄] (I) and to a substrate which has on one surface a tungsten layer or a layer containing tungsten which are suitable for producing photovoltaic elements, semiconductor elements or car exhaust catalytic converters. The method permits the preparation of defined products in a simple, cost-effective and reproducible manner in high purity and good to very good yields.

Tungsten(VI) oxo-alkoxides of type [W(O)(OR)₄], such as [W(O)(iPr)₄] and [W(O)(sBu)₄], and methods for the preparation thereof, are known in the prior art. Some volatile representatives of this group of tungsten compounds are used as precursors for WO₃.

For many possible applications, such as for the production of a semiconductor element, a photoelement, a photovoltaic cell or a catalyst (that is to say a catalytically active organic or inorganic compound or a carrier for a car exhaust catalytic converter coated with at least one catalytically active layer), precursor compounds, such as [W(O)(OR)₄], must be preparable simply, cost-effectively, and in large quantities and fulfill high purity specifications.

Suitable for this purpose are, for example, precursor compounds, such as [W(O)(OR)₄], suitable for methods for producing a semiconductor element, a photoelement, a photovoltaic cell or catalyst, i.e. a catalytically active organic or inorganic compound

In the prior art, the preparation of compounds of the type offered [W(O)(OR)₄] is conventionally carried out originating from WOCl₄. The target compounds [W(O)(OR)₄] are obtained by reaction with i) the free alcohol and ammonia or ii) the corresponding lithium alcoholate.

The first synthesis route of i), originating from WOCl₄ and the corresponding alcohol and ammonia, is described by H. Funk et al. for R=Me, Et, iPr, nBu, C₆H₁₁. Benzene is used as solvent. (Z. Anorg. Allg. Chem. 1960, 304, 238-240) To selectively obtain the chloride-free compounds, the introduction of NH₃ gas is required. This gives rise to large amounts of NH₄Cl. In order to prevent a large part of the desired products from precipitating out together with the NH₄Cl load produced, at least three times the amount of alcohol necessary to replace the four chlorine atoms must be added. A particular problem with this route is the use of the hydrolysis-sensitive reactant WOCl₄, which in a preceding reaction step must be prepared, isolated and purified by sublimation before being used further.

The synthesis route ii) is described in WO 2016/006231 A1 inter alia for [W(O)(OsBu)₄], with sBuOH, nBuLi and WOCl₄ being used as reactants. Tetrahydrofuran and toluene are used as solvents. After a vacuum distillation, the product is present in the form of a slightly yellow liquid. The yield is 73% (87 mmol). After sublimation, [W(O)(OiPr)₄] with a yield of 46% (5.5 mmol) is obtained. When the attempt was made to upscale the preparation of [W(O)(OiPr)₄], originating from 144 mmol of WOCl₄, an unidentifiable brown oil was isolated. Therefore, preparation of [W(O)(OiPr)₄] on an industrial scale is considered to be difficult (see paragraph [0093]). A disadvantage of this preparation method is the production of four equivalents of LiCl, which is difficult or impossible to separate out, in particular from ethereal solutions. Moreover, the formation of inseparable lithium tungstate complex salts can occur. (Z. A. Starikova et al., Polyhedron 2002, 21, 193-195 and V. G. Kessler et al., J. Chem. Soc., Dalt. Trans. 1998, 21-29)

S. I. Kucheiko et al. describe, in Koord. Khimiya 1985, 11, 1521-1528, the preparation of [W(O)(OR)₄] (R=Me, Et, iPr, tBu) originating from WOCl₄ and the corresponding NaOR in an ROH/Et₂O solvent mixture. The synthesis of [W(O)(OtBu)₄] is carried out originating from WOCl₄ and LiOtBu in THF.

A significant disadvantage of the known procedures for the preparation of compounds of type [W(O)(OR)₄] is the use of WOCl₄, which is not commercially available. In a preceding synthesis, the hydrolysis-sensitive reactant WOCl₄ must be prepared, isolated and purified by sublimation before being used further. Thus, its preparation not only represents an additional synthesis step, but is also complex and cost-intensive. The use of nBuLi to prepare the LiOR lithium alcoholates is likewise complex and cost-intensive in terms of preparation. A further disadvantage is that large amounts of inorganic salts, such as LiCl or NH₄Cl, are produced and are difficult to separate in many cases. This is because the reactions are usually carried out in THF or alcohols as solvents. If lithium ions are present in the reaction mixture, the formation of lithium tungstate complex salts, such as Li[W(O)(OR)₅], which are likewise difficult or impossible to separate, may also occur.

Moreover, the specifications known from the literature typically provide a complex purification by fractional distillation and/or sublimation. Nevertheless, the products obtained in this way can contain salt impurities which cannot be precisely quantified, and therefore the properties of said products—in comparison with the products in pure form—can be altered or impaired in a non-controllable and in some cases irreversible manner. In addition, with the reaction procedures described above, yields are obtained which are comparatively low in view of the industrial use of these compounds.

As a whole, the synthesis routes documented in the literature can be classified as unsatisfactory from ecological and economic perspectives.

The object of the invention is therefore to overcome these and other disadvantages of the prior art and to provide a method by means of which defined oxido (tetraalkoxido) tungsten compounds can be prepared in a simple, cost-effective and reproducible manner with high purity and good yields and low silicon content. In particular, the purity of the oxido (tetraalkoxido) tungsten compounds should satisfy the requirements of precursors for producing high-quality substrates which have tungsten layers or layers containing tungsten. The method should be characterized by the fact that it can also be carried out on an industrial scale with a comparable yield and purity of the target compounds. In addition, novel oxido (tetraalkoxido) tungsten compounds are to be provided. Furthermore, a substrate is to be provided which on one surface has a tungsten layer or a layer containing tungsten, which can be produced using an oxido (tetraalkoxido) tungsten compound obtainable or obtained by the claimed method or using one of the novel oxido (tetraalkoxido) tungsten compounds.

The main features of the invention are defined in the claims

The object is achieved by a method for the preparation of oxido (tetraalkoxido) tungsten compounds according to the general formula

[W(O)(OR)₄] (I)

wherein

R is selected from the group consisting of a straight-chain, branched or cyclic (C5-C10) alkyl group, a straight-chain, branched or cyclic partially or fully halogenated (C5-C10) alkyl group, an alkylene alkyl ether group (R^{E}-O)ₙ-R^{F}, a benzyl group, a partially or fully substituted benzyl group, a mononuclear or polynuclear aryl, a partially or fully substituted mononuclear or polynuclear aryl, a mononuclear or polynuclear heteroaryl and a partially or fully substituted mononuclear or polynuclear heteroaryl,

wherein
R^{E} are selected independently of one another from the group consisting of a straight-chain, branched or cyclic (C1-C6) alkylene group and a straight-chain, branched or cyclic partially or fully halogenated (C1-C6) alkylene group,
R^{F} are selected independently of one another from the group consisting of a straight-chain, branched or cyclic (C1-C10) alkyl group, a straight-chain, branched or cyclic partially or fully halogenated (C1-C10) alkyl group, and
n=1 to 5 or 1, 2 or 3

comprising the following steps:

a) reacting WCl₆ with hexamethyldisiloxane in an aprotic solvent in a reaction vessel,
b) removing by-products and solvents by distillation,
c) adding an alcohol ROH, wherein R is as defined above; and
a molar ratio of WCl₆:ROH is at least 1:4, and
d) supplying ammonia NH₃ or at least one amine; (which can take place both by introduction as gas or liquid, to a solution or by pressurization via the reaction solution, in a closed pressure vessel).
e) separating out precipitated by-products (such as ammonium chloride or, when an amine is used, the chloride of the amine).

In this case, the general formula I includes both the monomers and any oligomers. For example, [W(O)(OiPr)₄] is present in the solid form as a dimer. (W. Clegg et al., J. Chem. Soc., Dalt. Trans. 1992, 1, 1431-1438) Both in formula (I), [W(O)(OR)₄], and in the alcohol ROH used, R can be not only a benzyl group, a partially or fully substituted benzyl group, a mononuclear or polynuclear aryl, a partially or fully substituted mononuclear or polynuclear aryl, a mononuclear or polynuclear heteroaryl and a partially or fully substituted mononuclear or polynuclear heteroaryl, a straight-chain, branched or cyclic alkyl group having five to ten carbon atoms, which may be non-, partially or fully halogenated; R can also correspond to the formula (R^{E}—O)ₙ-R^{F}.

In this case, n is an integer from 1 to 5, such as 4, in particular 1, 2 or 3.

If R corresponds to the formula (R^{E}—O)ₙ—R^{F}, and if n is greater than 1, i.e. 2, 3, 4 or 5, multiple R^{E} groups may be present. These may be the same or different, and the R^{E} groups may be selected independently of one another from the group consisting of a straight-chain, branched or cyclic alkylene group having one to six carbon atoms, a partially or fully a straight-chain, branched or cyclic halogenated (C1-C6) alkylene group having one to six carbon atoms. This means that, for example, when n is 2, the formula (R^{E}—O)ₙ—R^{F} is (R^{E1}—O)—(R^{E2}—O)—R^{F}, wherein R^{E1} and R^{E2} may be the same, i.e. for example n-propyl, or else R^{E1} may be n-propyl and R^{E2} may be n-butyl, or else R^{E1} and R^{E2} are isomers of one another, i.e. for example with R^{E1} being n-propyl and R^{E2} being isopropyl. However, it is also possible for multiple isomeric or different groups to be used, so that a mixture of different R^{E} groups and therefore different R groups are present in ROH and (R^{E}—O)ₙ—R^{F}, which in turn leads to isomer mixtures of [W(O)(OR)₄].

When the R group corresponds to the formula (R^{E}—O)ₙ—R^{F}, the R^{F} group can be independently selected from the group consisting of a straight-chain, branched or cyclic alkyl group having one to ten (C1-C10), in particular three to seven (C3-C7), a straight-chain, branched or cyclic, partially or fully halogenated alkyl group having one to ten carbon atoms (C1-C10). However, the R^{F} groups can also differ as the R^{E} groups differ and can thus lead to different R groups. If different R^{F} and/or R^{E} groups and thus different R groups are present, as stated above, then the alcohols ROH used are mixtures.

In one embodiment of the method, the alcohol ROH is selected from the group consisting of sBuCH₂OH, iBuCH₂OH, (iPr)(Me)CHOH, (nPr)(Me)CHOH, (Et)₂CHOH, (Et)(Me)₂COH, C₆H₁₁OH, C₆H₅CH₂OH and C₆H₅OH.

In a further variant of the method, the alcohol ROH is selected from the group consisting of 2-fluoroethanol, 2,2-dichloro-2-fluoroethanol, 2- chloroethanol, 2-bromoethanol, 2,2-dibromoethanol, 2,2,2-tribromoethanol, hexafluoroisopropanol,(2,2-dichlorocyclopropyl)methanol and (2,2-dichloro-1-phenylcyclopropyl)m ethanol.

In another embodiment of the method, the alcohol ROH is a glycol ether. Polyethers are also understood as glycol ethers. In one variant of the method, the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether. In a further embodiment of the method, the glycol ether is selected from the group consisting of methyl glycol CH₃—O—CH₂CH₂—OH, ethoxyethanol CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)2CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH and iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (optionally isomer mixture), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH,1-propoxy-2-propanol C₃H₇OCH₂CH₂CH₂OH and mixtures thereof. The stated glycol ethers can also be used as isomer mixtures.

The aprotic solvent can also be a solvent mixture.

The term reaction vessel is not limited to a volume, a material property, equipment and/or a shape.

The completeness of the reaction or the end of the reaction in step d) can be determined by the fact that, for example, ammonia supplied in gaseous form is no longer captured by the reaction mixture but flows through the reaction mixture, the falling of the temperature of the reaction mixture or a decrease in the exothermicity, or combinations thereof. For example, a bubble counter, a pressure relief valve and/or a pressure sensor, mass flow meter or flowmeter, temperature sensor or temperature switch can be used for this purpose. If the completeness of the reaction is determined with a time delay, excess NH₃ gas can simply be removed from the reaction mixture by creating a negative pressure in the reaction vessel. It is possible to proceed similarly when ammonia or amine is supplied in gaseous form under pressure, in a liquid state or as a solution.

After their isolation, the complexes of type [W(O)(OR)₄] which can be prepared by the method described here have demonstrably no amine or NH₃, or an amine or NH₃ content below the analytical detection limit—according to IR spectra and elemental analyses. This suggests that an NH₃ adduct of the particular target compound is only present—if at all—in solution. An excessively long introduction of NH₃ gas beyond the end of the reaction is disadvantageous, at least from an ecological and economic point of view.

The claimed method advantageously enables the preparation of the target compounds [W(O)(OR)₄] in a one-pot synthesis, which means that the intermediate of step a), the reaction of WCl₆ with hexamethyldisiloxane, is not isolated; instead, only by-products are distilled off in step b). The inexpensive, commercially available WCl₆ is used as reactant. Starting therefrom, the hydrolysis-sensitive tungsten(VI) compound WOCl₄ is prepared by reaction with hexamethyldisiloxane (TMS₂O) in an aprotic solvent according to step a). This is particularly advantageous because it eliminates the complex isolation and purification by sublimation of WOCl₄, which in this case is merely an intermediate. The respective oxido (tetraalkoxido) tungsten complex is obtained in step c) by adding at least four molar equivalents of ROH in relation to WCl₆, only four molar equivalents of ROH being required for the preparation of the particular target compound. The by-product trimethylsilyl chloride (TMSCI) produced in step a) competes in step c) with the reaction to give the desired end product, with a side reaction by likewise reacting with ROH to form the defined compound TMSOR, which, with the R groups used here, are not only comparatively nonvolatile, but also require two additional equivalent ROH to ensure complete reaction of the WOCl₄. Surprisingly, it was found that these silicon-containing by-products are difficult to separate from the desired end product [W(O)(OR)₄], but their formation can be avoided in an incredibly simple manner by the distillation carried out in step b). According to step d), the hydrogen chloride formed in step c) is captured by supplying ammonia or an amine, for example by introducing NH₃ gas. With the claimed one-pot method, only the desired oxido (tetraalkoxido) tungsten compound of the type stated [W(O)(OR)₄] is present after steps a) to d) have been carried out, as well as possibly solvent, the defined, easily separable by-product from the reaction of amine or ammonia, such as ammonium chloride NH₄Cl, and possibly small amounts of TMSOR contamination. These impurities may generally be present in amounts of less than two weight percent (<2%), less than 1 wt. % and in particular less than 0.5 wt. %. The simple separability, for example by filtration or centrifugation and/or decantation of the by-product, can also be provided with the advantageous selection of an aprotic solvent. If, for example, heptane or another aliphatic solvent or dichloromethane is used as solvent, NH₄Cl in particular precipitates quantitatively, while the target compound, for example [W(O)(OiPr)₄], remains in solution. Contamination of the respective tungsten(VI) oxo-alkoxide by the NH₄Cl load produced is thus advantageously significantly reduced. Furthermore, it is advantageous that undefinable by-products such as, for example, lithium tungstate complex salts, which are difficult or impossible to separate out, are not formed.

The particular target compound in solution can be reacted directly with one or more further reactants. Alternatively, the compound of type [W(O)(OR)₄] may be isolated, for example by simple filtration, optionally with filtering aids such as activated carbon, an aluminosilicate or silica, followed by removal of any volatile constituents such as solvents. It is particularly advantageous that NH₄Cl can be removed simply and approximately quantitatively, preferably quantitatively, by a filtration step. Furthermore, the isolated compound advantageously does not contain NH₃— or silicon-containing impurities, or residues of the solvent or solvent mixture used. In general, the end product may still contain residues of solvent, TMSOR, hexamethyldisiloxane or the defined, easily separable by-product from the reaction of amine or ammonia, such as ammonium chloride NH₄Cl. The end product therefore has at least a purity of 97%, advantageously of more than 97%, in particular of more than 98% or 99%. The target compound can thus be used and/or stored after isolation without further purification. Depending on the choice of alcohol ROH and the solvent or solvent mixture, the reproducible yield is usually>80%>or 90%, even in the case of upscaling to industrial use.

As a whole, the method claimed overcomes the disadvantages of the prior art. In particular, significantly lower contamination by difficult-to-separate salt loads, such as LiCl in THF or NH₄Cl in an alcohol ROH, results. The method is characterized by a particularly simple and cost-effective procedure because it is a one-pot synthesis. In addition, few method steps are needed, which are easily accomplished in terms of preparation and are easily scalable. Commercially readily available and cost-effective reactants are used. Definable by-products are produced which can be separated out easily and well, almost quantitatively, advantageously quantitatively. In particular, the formation of inseparable lithium tungstate complex salts, such as Li[W(O)(OR)₅], does not occur. The desired oxido (tetraalkoxido) tungsten compound is therefore obtained reproducibly in improved, high purity without further purification by distillation and/or sublimation. In particular, the oxido (tetraalkoxido) tungsten compounds which can be prepared by the claimed method meet the purity requirements of precursors for producing high-quality substrates which comprise tungsten layers or tungsten-containing layers. The yields are good to very good, are reproducible and exceed the yields of the synthesis methods known from the literature. In addition, the method can also be carried out on an industrial scale, wherein comparable yields and purity of the target compounds are achieved. The claimed method saves time, energy and costs. Overall, it can be classified as more economical in comparison.

If one of the aforementioned alcohols is used, the claimed method enables compounds of type [W(O)(OR)₄] to be prepared in a simple and reproducible manner in high purity and in good to very good yields.

In a further variant of the method, the aprotic solvent is selected from the group consisting of aliphatic solvents, benzene derivatives and halogenated hydrocarbons. The aprotic solvent is, for example, pentane, hexane, isohexane, heptane, octane, decane, toluene, xylene, dichloromethane, trichlorom ethane, tetrachloromethane, 1,2-dichloroethane, 1,1,1-trichloroethane, trichloroethene or tetrachloroethene. Solvent mixtures can also be used. If isolation of the product is desired, the by-product NH₄Cl is separated out particularly simply and rapidly when one of these solvents or a mixture of one or more of these solvents is used. In particular, the solvents pentane, isohexane, heptane, toluene, dichloromethane, trichloromethane, tetrachloromethane, 1,2-dichloroethane and trichloroethene can advantageously be completely recycled without losses. This has a positive effect on the life cycle assessment of the method.

In a further embodiment of the method, in step a) the reaction of WCl₆ with hexamethyldisiloxane in the aprotic solvent in the reaction vessel comprises the following steps:

i) providing a solution or suspension of WCl₆ in the aprotic solvent,
ii) adding hexamethyldisiloxane,
wherein during the addition and/or after the addition of hexamethyldisiloxane, a reaction of WCl₆ with hexamethyldisiloxane takes place.

The aprotic solvent may also be a solvent mixture or an isomer mixture.

In one embodiment of the method, a molar ratio of WCl₆:hexamethyldisiloxane is at least 1:1.

In a variant of the method, in step a) ii) the addition of hexamethyldisiloxane to the solution or suspension of WCl₆ in the aprotic solvent takes place using a metering device. The addition can be carried out, for example, by dropwise addition or injection. Alternatively or additionally, a shut-off valve and/or a stopcock and/or a metering pump can be provided in a supply line of the reaction vessel.

In a further embodiment of the method, a solution of hexamethyldisiloxane in a solvent S is added to the solution or suspension of WCl₆ in the aprotic solvent, the solvent S in which hexamethyldisiloxane is dissolved being miscible with or identical to the aprotic solvent in which WCl₆ is dissolved or suspended. Depending on the other reaction parameters, this can be advantageous for better control of the course of the reaction or of the exothermicity.

Depending on the choice of the aprotic solvent or solvent mixture and the other reaction conditions, such as, for example, the form in which the hexamethyldisiloxane is added, i.e. in bulk or dissolved in a solvent, rate of addition of hexamethyldisiloxane, stirring rate, internal temperature of the reaction vessel, the reaction of WCl₆ with hexamethyldisiloxane already takes place during the addition and/or after the addition of hexamethyldisiloxane.

In another variant of the method, the reaction of WCl₆ with hexamethyldisiloxane in the aprotic solvent is carried out at an internal temperature T_{U} of the reaction vessel, the internal temperature T_{U} being between 0° C. and 150° C. Owing to the exothermicity of the reaction, it may be advantageous to select the rate of addition of hexamethyldisiloxane and/or the internal temperature T_{U} of the reaction vessel to be comparatively low. Alternatively or additionally, it may be provided for a solution of hexamethyldisiloxane in an aprotic solvent or solvent mixture to be added. The respective procedure should be selected taking into account the other reaction parameters, such as the WCl₆ concentration and the solvent or solvent mixture.

An internal temperature of the reaction vessel may be determined using a temperature sensor or a plurality of temperature sensors for one or more regions of the reaction vessel. At least one temperature sensor is provided for determining the internal temperature T_{U}, which generally corresponds to an average temperature T_{D1} of the reaction mixture.

In a further embodiment of the method, the internal temperature T_{U} of the reaction vessel is between 0° C. and 140° C. or from 10° C. to 140° C. In yet another embodiment of the method, the internal temperature T_{U} of the reaction vessel during the reaction of WCl₆ with hexamethyldisiloxane is between 10° C. and 100° C. or from 20° C. to 100° C.

In a further variant of the method, the internal temperature T_{U} of the reaction vessel is regulated and/or controlled using a heat transfer medium W_{U}. For example, a cryostat can be used for this purpose, containing a heat transfer medium which ideally can function both as a coolant and as a heating means. The use of the heat transfer medium W_{U} allows any deviations of the internal temperature T_{U} from a setpoint value T_{S1} defined for the reaction of WCl₆ with hexamethyldisiloxane to be largely absorbed or compensated. A constant internal temperature T_{U} can be implemented only with difficulty due to the usual device deviations. However, by using the heat transfer medium W_{U}, the reaction of WCl₆ with hexamethyldisiloxane can be carried out at least within a preselected temperature range or within multiple preselected temperature ranges. For example, it may be advantageous, depending on the other reaction parameters, to create a temperature program for even better control of the course of the reaction or the exothermicity. For example, a lower temperature or a lower temperature range may be selected during a first phase of the addition of hexamethyldisiloxane than in a second phase of the addition of hexamethyldisiloxane. It is also possible to provide more than two phases of addition and thus more than two preselected temperatures or temperature ranges. Depending on the choice of the other reaction conditions, such as, for example, the WCl₆ concentration and the solvent or solvent mixture, it may be favorable during the addition and/or after the addition of hexamethyldisiloxane to increase the internal temperature T_{U} of the reaction vessel using the heat transfer medium W_{U}. It can thereby optionally be ensured that the reaction of WCl₆ with hexamethyldisiloxane takes place quantitatively. The duration of the increase in the internal temperature T_{U} of the reaction vessel using the heat transfer medium W_{U} can be, for example, between 10 min and 6 h.

In an additional embodiment of the method, the molar ratio of WCl₆:ROH is at least 1:4, or is between 1:4 and 1:40 or 1:6.1 and 1:40 or 1:4 and 1:6.1. The molar ratio is selected depending on the respective reactant ROH and the aprotic solvent or solvent mixture in question.

In step b), the solvent and/or solvent and the TMSCI produced as a by-product in step a) are removed by distillation. At laboratory scale, a distillation bridge is attached after the end of the reaction of WCl₆ with hexamethyldisiloxane for this purpose. Suitable industrial plants are usually already designed accordingly and provided with corresponding equipment. The distillation can advantageously be carried out in a gentle manner under reduced pressure. Pressures of approximately 50 mbar to approximately 250 mbar, in particular 120 mbar to approximately 220 mbar, have proven effective here. Suitable temperatures are usually from approximately 30° C. to approximately 50° C. in order to bring about gentle distillation, for example by distillation at 40° C. and a pressure of 170 mbar. If no more distillate is collected (the top temperature of the distillation bridge used also decreasing), the pressure can be reduced further in steps, for example in steps of 10 mbar each, until distillate is distilled over again and the distillation ceases again. If the pressure is approximately 50 mbar below the pressure during the start of the distillation, drag distillation can be carried out and approximately 10% to approximately 50%, in particular approximately 20% to approximately 40%. In one variant of the method, the alcohol ROH is added in step c) using a metering device. The addition can be carried out, for example, by dropwise addition or injection. Alternatively or additionally, a shut-off valve and/or a stopcock or a metering pump can be provided in a supply line of the reaction vessel.

In a further embodiment of the method, a solution of the alcohol ROH in a solvent M is added to the reaction mixture from step b), the solvent M in which the alcohol ROH is dissolved being miscible with or identical to the aprotic solvent from step a). Depending on the other reaction parameters, this can be advantageous for better control of the course of the reaction or of the exothermicity.

In another variant of the method, an internal temperature T_{C} of the reaction vessel during the addition and/or after the addition of the alcohol ROH is between −30° C. and 50° C. In a further variant of the method, the internal temperature T_{C} of the reaction vessel during the addition and/or after the addition of the alcohol ROH is between −25° C. and 30° C. In yet another embodiment of the method, the internal temperature Tc of the reaction vessel during the addition and/or after the addition of the alcohol ROH is between −15° C. and 20° C. At least one temperature sensor is provided for determining the internal temperature T_{C}, which generally corresponds to an average temperature T_{D2} of the reaction mixture. The temperature sensor may be identical to that for determining the internal temperature T_{U}.

In a further embodiment of the method, the internal temperature T_{C} of the reaction vessel is regulated and/or controlled using a heat transfer medium W_{C}. For example, a cryostat can be used for this purpose, containing a heat transfer medium which ideally can function both as a coolant and as a heating means. The use of the heat transfer medium W_{C} allows deviations of the internal temperature T_{C} from a setpoint value T_{S2} defined for the time during the addition and/or after the addition of the alcohol ROH to be largely absorbed or compensated. A constant internal temperature T_{C} is almost impossible to implement due to the usual device deviations. However, by using the heat transfer medium W_{C}, the reaction of the WOCl₄ produced in step a) with ROH can be carried out at least within a preselected temperature range or within multiple preselected temperature ranges. For example, it may be advantageous, depending on the other reaction parameters, to create a temperature program for even better control of the course of the reaction or the exothermicity. For example, a lower temperature or a lower temperature range may be selected during a first phase of the addition of the alcohol ROH than in a second phase of the addition of the alcohol ROH. It is also possible to provide more than two phases of addition and thus more than two preselected temperatures or temperature ranges.

In a further embodiment of the method, an internal temperature T_{N} of the reaction vessel during step d) and/or thereafter is between −30° C. and 100° C. or between −25° C. and 80° C. or between −20° C. and 60° C. In this step d), ammonia or amine is supplied, which can be effected by introducing gaseous or liquid amine or ammonia, a solution of ammonia or amine, or by pressurizing amine or NH₃ gas. With pressurization, a pressure of from 1 mbar to 6 bar, in particular from 100 mbar to 4.5 bar, can be selected. At least one temperature sensor is provided for determining the internal temperature T_{N}, which generally corresponds to an average temperature T_{D3} of the reaction mixture. The temperature sensor can be identical to that for determining the internal temperature T_{U} and/or the internal temperature T_{C}. When amine is used, it is generally possible to use different amines, including as a mixture, such as primary, secondary or tertiary amines. Alkylamines can advantageously be used here. These may be methylamine, ethylamine, propylamine, isopropylamine, butylamine, tert-butylamine, cyclohexylamine, dimethylamine, diethylamine, dipropylamine, diisopropylamine, dibutylamine, di-tert-butylamine, dicyclohexylamine, trimethylamine, triethylamine, tripropylamine, triisopropylamine, tributylamine, tri-tert-butylamine, tricyclohexylamine or mixtures thereof. Mixed substituted amines and mixtures thereof are also conceivable, such as diisopropylethylamine (DIPEA). Urotropine, acetamidine, ethylenediamine, triethylenetetramine, morpholine, N-methylmorpholine, 1,8-diazabicyclo[5.4.0]undec-7-ene (DBU), 1,4-diazabicyclo[2.2.2]octane (DABCO®), N,N,N′,N′-tetramethylethylenediamine (TMEDA), pyridine, pyrazole, pyrimidine, imidazole, guanidine, hexamethyldisilazane or combinations thereof may likewise be used.

In another embodiment of the method, the internal temperature T_{N} of the reaction vessel is regulated and/or controlled using a heat transfer medium W_{N}. For example, a cryostat can be used for this purpose, containing a heat transfer medium which ideally can function both as a coolant and as a heating means. The use of the heat transfer medium W_{N} allows deviations of the internal temperature T_{N} from a setpoint value T_{S3} defined for the time during the introduction and/or after the introduction to be largely absorbed or compensated. A constant internal temperature T_{N} is almost impossible to implement due to the usual device deviations. However, by using the heat transfer medium W_{N}, step d) can be carried out at least within a preselected temperature range or within multiple preselected temperature ranges. For example, it may be advantageous, depending on the other reaction parameters, to create a temperature program for even better control of the course of the reaction or the exothermicity.

In another variant of the method, an internal temperature T_{N1} of the reaction vessel during a first phase of supplying the ammonia or amine by introduction in a liquid or gaseous state or as a solution or by pressurization is between −30° C. and 20° C., and an internal temperature T_{N2} of the reaction vessel during a second phase and/or after the second phase of supplying or introducing or pressurizing amine or NH₃ gas is between 21° C. and 100° C. In a further embodiment, the internal temperature T_{N2} of the reaction vessel during the second phase and/or after the second phase of supplying or introducing or pressurizing amine or NH₃ gas is between 22° C. and 80° C. In a further modification of this embodiment, the internal temperature T_{N2} of the reaction vessel during the second phase and/or after the second phase of supplying or introducing or pressurizing amine or NH₃ gas is between 23° C. and 60° C. At least one temperature sensor is provided for determining the internal temperatures T_{N1} and T_{N2}, the internal temperatures T_{N1} and T_{N2} generally corresponding to an average temperature T_{D4} and TD₅, respectively, of the reaction mixture. The temperature sensor for determining the internal temperature T_{N1} can be identical to that for determining the internal temperature T_{N2} and/or to that for determining the internal temperature T_{U} and/or to that for determining the internal temperature T_{C}.

Depending on the choice of the other reaction parameters, such a temperature program for the supply or introduction or the pressurization of NH₃ gas enables an even better control of the exothermicity and/or the course of the reaction.

The duration of the supply or introduction or pressurization of amine or NH₃ gas, as well as the choice of the internal temperature T_{N} or T_{N1} and T_{N2} of the reaction vessel, are dependent on, inter alia, the batch size, the choice of the reactant ROH and the choice of solvent or solvent mixture.

If a first phase and a second phase of supplying or introducing or pressurizing amine or NH₃ gas are carried out, the two phases may differ in terms of the length in time. For example, the first phase at the comparatively lower internal temperature T_{N1} of the reaction vessel may span a longer period of time than the second phase at the comparatively higher internal temperature T_{N2} of the reaction vessel. Thus, the first phase of supplying or introducing or pressurizing amine or NH₃ gas can take e.g. one hour, where T_{N1}<20° C., and the second phase of supplying or introducing or pressurizing amine or NH₃ gas can take 30 min, where T_{N2}≥21° C. This procedure is advantageous—depending on the choice of reactant ROH and the choice of solvent—for achieving quantitative capture of the released hydrogen chloride, converting it, for example, to NH₄Cl. In another embodiment of the method, the first phase of supplying or introducing or pressurizing amine or NH₃ gas and the second phase of supplying or introducing or pressurizing amine or NH₃ gas take identical periods of time. This makes the procedure comparatively simpler.

In another embodiment of the method, after step d), a step e) is carried out which comprises separating out precipitated by-products and impurities. If the oxido (tetraalkoxido) tungsten compound in solution in each case is not to be subjected directly to a further reaction, but rather isolated and then stored and/or further used, the separation may comprise one or more steps.

Any by-products produced are removed for this purpose. In this case, the chloride captured by reaction with amine or ammonia can primarily be separated out as precipitated ammonium chloride or ammonium salt (such as diethylammonium chloride). This can in principle be achieved using all suitable methods.

Suitable for this purpose is, for example, filtration, in which case the filter cake can advantageously be subsequently washed with the solvent used. Likewise, the precipitated by-products may be sedimented or centrifuged, and the solution of the product [W(O)(OR)₄] may be separated out by decantation.

In one embodiment, the separation takes place by filtration; in a second stage, remaining, insoluble by-products or impurities are likewise separated out by centrifugation and subsequent decantation.

In one variant of the method, the isolation comprises a filtration step. Multiple filtration steps can also be provided, optionally including one or more filtrations via a cleaning medium, such as activated carbon, an aluminosilicate or silica, so that soluble impurities and fine fractions can also be removed.

The filter cake, which can also comprise the NH₄Cl load, may be provided with a small amount of a volatile solvent, such as e.g. CH₂Cl₂, and washed in order to extract any product contained in the NH₄Cl load. In a specific embodiment, the solvent used as reaction medium is used for washing. In a further embodiment, a step f) may then be carried out, which comprises isolation of [W(O)(OR)₄]. The isolation may comprise further method measures, such as, for example: the reduction of the volume of the mother liquor, i.e. concentration, for example by means of “bulb to bulb”; the addition of a solvent and/or a solvent exchange in order to achieve crystallization or precipitation of the product out of the mother liquor and/or to remove impurities and/or reactants; washing and drying of the product; recrystallization; distillation; and/or sublimation. In a specific embodiment, in step f) the solvent used is separated off by distillation (in vacuo).

The object is also achieved by oxido (tetraalkoxido) tungsten compounds in accordance with the general formula

[W(O)(OR)₄] (I)

wherein

R is selected from the group consisting of a straight-chain, branched or cyclic (C5-C10) alkyl group, a straight-chain, branched or cyclic partially or fully halogenated (C5-C10) alkyl group, an alkyl ether group (R^{E}—O)ₙ—R^{F}, a benzyl group, a partially or fully substituted benzyl group, a mononuclear or polynuclear aryl, a partially or fully substituted mononuclear or polynuclear aryl, a mononuclear or polynuclear heteroaryl and a partially or fully substituted mononuclear or polynuclear heteroaryl,

wherein

R^{E} are selected independently of one another from the group consisting of a straight-chain, branched or cyclic (C1-C6) alkylene group and a straight-chain, branched or cyclic partially or fully halogenated (C1-C6) alkylene group,
R^{F} are selected independently of one another from the group consisting of a straight-chain, branched or cyclic (C1-C10) alkyl group, a straight-chain, branched or cyclic partially or fully halogenated (C1-C10) alkyl group, and

n=1 to 5 or 1, 2 or 3, in particular obtainable by a method for the preparation of oxido (tetraalkoxido) tungsten compounds according to one of the exemplary embodiments described above.

The tungsten(VI) oxo-alkoxides of type [W(O)(OR)₄] may advantageously be prepared in a particularly simple and cost-effective manner in a one-pot synthesis. The oxido (tetraalkoxido) tungsten compounds can be prepared reproducibly in high purity without further purification by distillation and/or sublimation. In particular, they meet the purity requirements of precursors for producing high-quality substrates which comprise tungsten layers or layers containing tungsten. The yields are good to very good and reproducible. In addition, the oxido (tetraalkoxido) tungsten compounds can also be prepared on an industrial scale, with comparable yields and purity of the target compounds being achieved.

Oxido (tetraalkoxido) tungsten compounds such as e.g. [W(O)(iPr)₄] and [W(O)(sBu)₄] are known in principle. Compounds of type [W(O)(OR)₄], which are obtainable by a method for the preparation of oxido (tetraalkoxido) tungsten compounds according to one of the exemplary embodiments described above, differ significantly in their properties from those which can be prepared by means of a method from the prior art. In particular, the isolated target compounds have, without complex purification, at least as high a purity as compounds of type [W(O)(OR)₄] which have been prepared by methods from the prior art and—as is customary in the literature—have been purified by means of fractional distillation and/or sublimation. In particular, the tungsten(VI) oxido-alkoxides obtainable by an exemplary embodiment of the method described above have proven to have no analytically detectable contamination by solvent or NH₃. For example, the isolated product [W(O)(OsBu)₄], which was only recondensed but not fractionally distilled, was at least as pure as a distilled comparative product prepared according to WO 2016/006231 (see paragraph [0075]) from WOCl₄, nBuLi and sBuOH in toluene/THF. This is shown by, inter alia, the elemental analyses and the IR spectra measured in bulk in FIG. 8 to FIG. 10. According to the IR spectrum in FIG. 8, in the case of the isolated, only recondensed product [W(O)(OsBu)₄] prepared by the claimed method (see experimental section, exemplary embodiment 3), no N—H oscillation is observed in the wavenumber range between 3100 cm⁻¹ and 3500 cm⁻¹ (see FIG. 8). FIG. 9 shows an IR spectrum for a crude product [W(O)(OsBu)₄], i.e. before an intended distillation, according to WO 2016/006231, paragraph [0075] (comparative example 2). In contrast to the IR spectrum in FIG. 8, this shows a deviating pattern of oscillation in the<1500 cm⁻¹ wavelength range, i.e. in the fingerprint range, which is specific to a substance. In the present case, the deviations are observed in particular in the<1000 cm⁻¹ range, in which metal halogen oscillations usually also appear. Accordingly, it can be seen from the IR spectrum in FIG. 9 that the crude product [W(O)(OsBu)₄] shown in comparative example 2 is not present in pure form before further purification. Only after distillation does the IR spectrum of the compound synthesized according to WO 2016/006231 (see FIG. 10) substantially show a match with the IR spectrum from FIG. 8 (exemplary embodiment 3).

In one embodiment of the oxido (tetraalkoxido) tungsten compounds according to the general formula [W(O)(OR)₄] (I), obtainable by a method for preparing oxido (tetraalkoxido) tungsten compounds according to one of the above described exemplary embodiments, R is selected from the group consisting of CH₂sBu, CH₂iBu, CH(Me)(iPr), CH(Me)(nPr), CH(Et)₂, C(Me)₂(Et), C₆H₁₁, CH₂C₆H₅ and C₆H₅.

In another embodiment of the oxido (tetraalkoxido) tungsten compounds according to the general formula [W(O)(OR)₄], obtainable by a method for preparing oxido (tetraalkoxido) tungsten compounds according to one of the exemplary embodiments described above, R is selected from the group consisting of 2-fluoroethyl, 2,2-dichloro-2-fluoroethyl, 2-chloroethyl, 2-bromoethyl, 2,2-dibromoethyl, 2,2,2-tribromoethyl, hexafluoroisopropyl, (2,2-dichlorocyclopropyl)methyl and (2,2-dichloro-1-phenylcyclopropyl)methyl.

In yet another variant of the oxido (tetraalkoxido) tungsten compounds according to the general formula [W(O)(OR)₄] (I), obtainable by a method for preparing oxido (tetraalkoxido) tungsten compounds according to one of the exemplary embodiments described above, OR is a corresponding base of a glycol ether. The glycol ether is selected, for example, from the group consisting of a monoethylene glycol monoether, a diethylene glycol monoether, a triethylene glycol monoether, a monopropylene glycol monoether, a dipropylene glycol monoether, a tripropylene glycol monoether, a monooxomethylene monoether, a dioxomethylene monoether and a trioxomethylene monoether.

In a further embodiment of the oxido (tetraalkoxido) tungsten compounds according to the general formula [W(O)(OR)₄] (I), obtainable by a method for preparing oxido (tetraalkoxido) tungsten compounds according to one of the previously described exemplary embodiments, OR is selected from the group consisting of O—CH₂CH₂—O—CH₃, O—CH₂CH₂—O—CH₂CH₃, O—CH₂CH₂—O—CH₂CH₂CH₃, O—CH₂CH₂—O—CH(CH₃)₂, O—CH₂CH₂—O—CH₂CH₂CH₂CH₃, O—CH₂CH₂—O—CH₂CH₂CH₂CH₂CH₃, O—CH₂CH₂—O—CH₂CH₂CH₂CH₂CH₂CH₃, O—CH₂CH₂—O—C₆H₅, O—CH₂CH₂—O—CH₂C₆H₅, O—CH₂CH₂—O—CH₂CH₂—O—CH₃, O—CH₂CH₂—O—CH₂CH₂—O—CH₂CH₃, O—CH₂CH₂—O—CH₂CH₂—O—CH₂CH₂CH₃, O—CH₂CH₂—O—CH₂CH₂—O—CH(CH₃)₂, O—CH₂CH₂—O—CH₂CH₂—O—CH₂CH₂CH₂CH₃, O—CH₂CH₂—O—CH₂CH₂—O—CH₂CH₂CH₂CH₂CH₃, O—CH₂CH₂—O—CH₂CH₂—O—CH₂CH₂CH₂CH₂CH₂CH₃, O—CH₂CH₂—O—CH₂CH₂—O—C₆H₅, O—CH₂CH₂—O—CH₂CH₂—O—CH₂C₆H₅, O—CH₂CH₂CH₂—O—CH₃, O—CH₂CH₂CH₂—O—CH₂CH₃, O—CH₂CH₂CH₂—O—CH₂CH₂CH₃, O—CH₂CH₂CH₂—O—CH(CH₃)₂, O—CH₂CH₂CH₂—O—CH₂CH₂CH₂CH₃, O—CH₂CH₂CH₂—O—CH₂CH₂CH₂CH₂CH₃, O—CH₂CH₂CH₂—O—CH₂CH₂CH₂CH₂CH₂CH₃, O—CH₂CH₂CH₂—O—C₆H₅, O—CH₂CH₂CH₂—O—CH₂C₆H₅, O—CH(CH₃)—CH₂—O—CH₃, O—CH(CH₃)—CH₂—O—CH₂CH₃, O—CH(CH₃)—CH₂—O—CH₂CH₂CH₃, O—CH(CH₃)—CH₂—O—CH(CH₃)₂, O—CH(CH₃)—CH₂—O—CH₂CH₂CH₂CH₃, O—CH(CH₃)—CH₂—O—CH₂CH₂CH₂CH₂CH₃, O—CH(CH₃)—CH₂—O—CH₂CH₂CH₂CH₂CH₂CH₃, O—CH(CH₃)—CH₂—O—C₆H₅, O—CH(CH₃)—CH₂—O—CH(CH₃)—CH₂—O—C₃H₇, O—CH(CH₃)—CH₂—O—CH₂C₆H₅, CH₃CH₂CH₂—O—CH₂CH(CH₃)OCH₂CH(CH₃)—O, CH₃OCH₂CH₂CH₂OCH₂CH₂CH₂—O, CH₃OCH₂CH₂CH₂—O, CH₃OCH₂CH₂CH₂OCH₂CH₂CH₂OCH₂CH₂CH₂—O, C₄H₉OCH₂CH₂CH₂OCH₂CH₂CH₂—O, C₄H₉OCH₂CH₂CH₂—O, C₄H₉OCH₂CH₂CH₂OCH₂CH₂CH₂OCH₂CH₂CH₂—O, C₃H₇OCH₂CH₂CH₂—O, the isomer mixtures thereof and combinations of these groups.

The invention relates to methods for producing a tungsten layer or a layer containing tungsten on a surface of a substrate using an oxido (tetraalkoxido) tungsten compound according to the general formula [W(O)(OR)₄] (I). The term “layer” is synonymous with the expression “film” and does not make any statement regarding the layer thickness or the film thickness. For example, corundum films, silicon wafers or metallic or ceramic carriers for car exhaust catalytic converters can be used as the substrate. The substrate itself may be part of a component such as a semiconductor element, photovoltaic element or a car exhaust catalytic converter or exhaust purification system. The deposition of the tungsten layer or the tungsten-containing layer may be carried out using a vapor deposition method, such as atomic layer deposition (ALD) or chemical vapor deposition (CVD).

Due to their high purity, the oxido (tetraalkoxido) tungsten compounds used are particularly suitable as precursors for producing high-quality tungsten layers and tungsten-containing layers on a surface of a substrate. In particular, they are free of contamination by solvents and NH₃, which are disadvantageous for the coating process and thus for the performance of the coated substrates. These coatings are well suited to producing a semiconductor element, a photoelement, a photovoltaic cell or catalyst, that is to say a catalytically active organic or inorganic compound or a carrier, coated with at least one catalytically active layer, for a car exhaust catalytic converter

Excluded are oxido (tetraalkoxido) tungsten compounds according to the general formula [W(O)(OR)₄] (I) in which the four R groups are independently of one another selected from the group consisting of a straight-chain, branched or cyclic C6-C8 alkyl group.

The tungsten(VI) oxo-alkoxides of type [W(O)(OR)₄] may advantageously be prepared in a particularly simple and cost-effective manner in a one-pot synthesis. The oxido (tetraalkoxido) tungsten compounds can be prepared reproducibly in high purity without further purification by distillation and/or sublimation. In particular, they meet the purity requirements of precursors for producing high-quality substrates which comprise tungsten layers or layers containing tungsten. The yields are good to very good and reproducible. In addition, the oxido (tetraalkoxido) tungsten compounds can also be prepared on an industrial scale, with comparable yields and purity of the target compounds being achieved.

In one embodiment of oxido (tetraalkoxido) tungsten compounds according to the general formula [W(O)(OR)₄] (I), R is selected from the group consisting of C₅H₁₁, C₅H₉, C₉H₁₉, C₁₀H₂₁ and C₆H₅.

In a further embodiment of the oxido (tetraalkoxido) tungsten compounds according to the general formula [W(O)(OR)₄] (I), R is selected from the group consisting of 2-fluoroethyl, 2,2-dichloro-2-fluoroethyl, 2-chloroethyl, 2-bromoethyl, 2,2-dibromoethyl, 2,2,2-tribromoethyl, hexafluoroisopropyl, (2,2-dichlorocyclopropyl)m ethyl and (2,2-dichloro-1-phenylcyclopropyl)methyl.

In another embodiment of the oxido (tetraalkoxido) tungsten compounds according to the general formula [W(O)(OR)₄] (I), OR is a corresponding base of a glycol ether. In one embodiment, the glycol ether is selected from the group consisting of a monoethylene glycol monoether, a diethylene glycol monoether, a triethylene glycol monoether, a monopropylene glycol monoether, a dipropylene glycol monoether, a tripropylene glycol monoether, a monooxomethylene monoether, a dioxomethylene monoether and a trioxomethylene monoether.

In a further embodiment of the oxido (tetraalkoxido) tungsten compounds according to the general formula [W(O)(OR)₄] (I), OR is selected from the group consisting of O—CH₂CH₂—O—CH₃, O—CH₂CH₂—O—CH₂CH₃, O—CH₂CH₂—O—CH₂CH₂CH₃, O—CH₂CH₂—O—CH(CH₃)₂, O—CH₂CH₂—O—CH₂CH₂CH₂CH₃, O—CH₂CH₂—O—CH₂CH₂CH₂CH₂CH₃, O—CH₂CH₂—O—CH₂CH₂CH₂CH₂CH₂CH₃, O—CH₂CH₂—O—C₆H₅, O—CH₂CH₂—O—CH₂C₆H₅, O—CH₂CH₂—O—CH₂CH₂—O—CH₃, O—CH₂CH₂—O—CH₂CH₂—O—CH₂CH₃, O—CH₂CH₂—O—CH₂CH₂—O—CH₂CH₂CH₃, O—CH₂CH₂—O—CH₂CH₂—O—CH(CH₃)₂, O—CH₂CH₂—O—CH₂CH₂—O—CH₂CH₂CH₂CH₃, O—CH₂CH₂—O—CH₂CH₂—O—CH₂CH₂CH₂CH₂CH₃, O—CH₂CH₂—O—CH₂CH₂—O—CH₂CH₂CH₂CH₂CH₂CH₃, O—CH₂CH₂—O—CH₂CH₂—O—C₆H₅, O—CH₂CH₂—O—CH₂CH₂—O—CH₂C₆H₅, O—CH₂CH₂CH₂—O—CH₃, O—CH₂CH₂CH₂—O—CH₂CH₃, O—CH₂CH₂CH₂—O—CH₂CH₂CH₃, O—CH₂CH₂CH₂—O—CH(CH₃)₂, O—CH₂CH₂CH₂—O—CH₂CH₂CH₂CH₃, O—CH₂CH₂CH₂—O—CH₂CH₂CH₂CH₂CH₃, O—CH₂CH₂CH₂—O—CH₂CH₂CH₂CH₂CH₂CH₃, O—CH₂CH₂CH₂—O—C₆H₅, O—CH₂CH₂CH₂—O—CH₂C₆H₅, O—C(CH₃)—CH₂—O—CH₃, O—C(CH₃)—CH₂—O—CH₂CH₃, O—C(CH₃)—CH₂—O—CH₂CH₂CH₃, O—C(CH₃)—CH₂—O—CH(CH₃)₂, O—C(CH₃)—CH₂—O—CH₂CH₂CH₂CH₃, O—C(CH₃)—CH₂—O—CH₂CH₂CH₂CH₂CH₃, O—C(CH₃)—CH₂—O—CH₂CH₂CH₂CH₂CH₂CH₃, O—C(CH₃)—CH₂—O—C₆H₅, O—CH(CH₃)—CH₂—O—CH(CH₃)—CH₂—O—C₃H₇ and O—C(CH₃)—CH₂—O—CH₂C₆H₅, CH₃CH₂CH₂—O—CH₂CH(CH₃)OCH₂CH(CH₃)—O, CH₃OCH₂CH₂CH₂OCH₂CH₂CH₂—O, CH₃OCH₂CH₂CH₂—O, CH₃OCH₂CH₂CH₂OCH₂CH₂CH₂OCH₂CH₂CH₂—O, C₄H₉OCH₂CH₂CH₂OCH₂CH₂CH₂—O, C₄H₉OCH₂CH₂CH₂—O, C₄H₉OCH₂CH₂CH₂OCH₂CH₂CH₂OCH₂CH₂CH₂—O, C₃H₇OCH₂CH₂CH₂—O, the isomer mixtures thereof and combinations of these groups.

Some of the aforementioned compounds of type [W(O)(OR)₄] have comparatively low melting points owing to the nature of the R group or of the ligand OR. Some representatives of these oxido (tetraalkoxido) tungsten compounds are present in liquid form at or slightly above room temperature. Relatively low-melting compounds of the general formula [W(O)(OR)₄] are particularly suitable as precursors for producing a high-quality tungsten layer or tungsten-containing layer on a surface of a substrate.

Owing to their high purity, the oxido (tetraalkoxido) tungsten compounds used are particularly suitable for the deposition of high-quality tungsten layers and layers of tungsten compounds, semiconductor applications, photovoltaics and catalysts or precursors thereof. In particular, they are free of contamination by solvents and NH₃, which are disadvantageous for performance in these applications.

The object is further achieved by the use of an oxido (tetraalkoxido) tungsten compound according to the general formula [W(O)(OR)₄] (I), obtained or obtainable by a method for preparing oxido (tetraalkoxido) tungsten compounds according to one of the exemplary embodiments described above, for producing a semiconductor element, a photoelement, a photovoltaic cell or catalyst, i.e. a catalytically active organic or inorganic compound or a carrier, coated with at least one catalytically active layer, for a car exhaust catalytic converter.

The invention relates to a method for producing a semiconductor element, a photoelement, a photovoltaic cell or a catalyst, i.e. a catalytically active organic or inorganic compound, using an oxido (tetraalkoxido) tungsten compound according to the general formula [W(O)(OR)₄] (I), obtained or obtainable by a method for preparing oxido (tetraalkoxido) tungsten compounds according to one of the exemplary embodiments described above, wherein

R is selected from the group consisting of a straight-chain, branched or cyclic (C5-C10) alkyl group, a straight-chain, branched or cyclic partially or fully halogenated (C5-C10) alkyl group, an alkyl ether group (R^{E}—O)ₙ—R^{F}, a benzyl group, a partially or fully substituted benzyl group, a mononuclear or polynuclear aryl, a partially or fully substituted mononuclear or polynuclear aryl, a mononuclear or polynuclear heteroaryl and a partially or fully substituted mononuclear or polynuclear heteroaryl,
wherein
R^{E} are selected independently of one another from the group consisting of a straight-chain, branched or cyclic (C1-C6) alkylene group and a straight-chain, branched or cyclic partially or fully halogenated (C1-C6) alkylene group,
R^{F} are selected independently of one another from the group consisting of a straight-chain, branched or cyclic (C1-C10) alkyl group, a straight-chain, branched or cyclic partially or fully halogenated (C1-C10) alkyl group, a benzyl group, a partially or fully substituted benzyl group, a mononuclear or polynuclear aryl, a partially or fully substituted mononuclear or polynuclear aryl, a mononuclear or polynuclear heteroaryl, and a partially or fully substituted mononuclear or polynuclear heteroaryl, and
n=1 to 5 or 1, 2 or 3

comprising the following steps:

a) providing the oxido (tetraalkoxido) tungsten compound according to the general formula [W(O)(OR)₄] (I),
b) processing the oxido (tetraalkoxido) tungsten compound according to the general formula [W(O)(OR)₄] (I) to form a semiconductor element, photoelement, photovoltaic cell or a catalytically active organic or inorganic compound, and
c) finishing the semiconductor element, the photoelement, the photovoltaic cell or a catalytically active organic or inorganic compound.

With the claimed method, defined oxido (tetraalkoxido) tungsten compounds can be prepared in a simple, cost-effective and reproducible manner in high purity and good to very good yields. After their isolation, the compounds which can be prepared in a one-pot reaction have, according to ¹H-NMR spectra, no contamination by reactants, by-products, decomposition products, solvents or the like. No complex purification of the respectively isolated crude product by fractional distillation and/or sublimation is required. Rather, no purification is necessary, i.e. the isolated crude product and the end product are identical, or, for example, a simple recondensation of the particular crude product is sufficient to obtain the end product. Because of their high purity, the compounds which can be prepared by the claimed method are suitable for use as precursors for producing high-quality substrates which comprise tungsten layers or layers containing tungsten. In addition, the claimed method is characterized in that it can also be carried out on an industrial scale with a comparable yield and purity of the target compounds. Overall, the claimed method can be assessed as satisfactory from ecological and economic standpoints.

Other characteristics, details, and advantages of the invention follow from the wording of the claims as well as from the following description of exemplary embodiments.

### EXAMPLES

### Comparative Example 1-3: General Procedure

Reaction of WCl₆ with (TMS)₂O, ROH and NH_{3(g)} in heptane without reaction step b)

WCl₆ (50.832 g; 128.17 mmol) is weighed into flasks and dissolved/suspended in 300 mL heptane (abs. or EMSURE). In a separate dropping funnel, 20.875 g (128.17 mmol, stoichiometric) of hexamethyldisiloxane are weighed in and diluted with heptane to give a 50 vol % solution. The hexamethyldisiloxane solution is metered in slowly over 30 min with stirring at an internal temperature of 19-30° C. After metering is complete, the reaction mixture is subsequently stirred for 3 hours. The color of the reaction solution changes from dark red-violet to orange-yellow.

To the reaction suspension are added 512.67 mmol of the corresponding alcohol or glycol ether (4.0 equivalents) dropwise at 0° C., with stirring, over a period of 30 min. The reaction mixture slowly changes color to a clear colorless or yellow solution.

After the end of the metering, the reaction solution is cooled to 15° C., and the feed temperature is set to 0° C. A gas introduction pipe is placed onto the apparatus, and the gas path is initially flushed with argon or nitrogen. Inert gas is then passed through the reaction solution for 10 min to displace excess HCl. After 10 min, ammonia is slowly introduced at a temperature of 10-15° C. The gas flow is initially so strong that the ammonia introduced is completely absorbed by the reaction solution. The temperature should be within a range of 0-40° C. during the introduction. The gas introduction is terminated as soon as the temperature of the reaction mixture falls and gas is blown off through the pressure relief valve. Inert gas is then passed through the reaction mixture again for 10 min. After 10 min, ammonia is again passed through the reaction mixture in order to ensure complete reaction. The excess ammonia is then flushed from the solution by inert gas, and the colorless reaction mixture is stirred for 16 h.

Following stirring, the reaction mixture is discharged onto a filter frit and filtered. After filtration is complete, the filter cake is washed with 3×200 mL of heptane. All volatile constituents are distilled off from the obtained filtrate in vacuo (10⁻³ mbar-1 mbar) at 40-60° C. The product obtained is then dried again for 4 h at 50-60° C. and 1×10⁻³ mbar from.

### Exemplary Embodiment 1-3: Analytical Data

Exemplary Embodiment 1: WO(OR)₄ where R=iPr; 4.0 eq. iPrOH; colorless solid, 81% yield

¹H-NMR (CDCl₃, 600 MHz, 300 K)δ(ppm)=1.30 (d, 6 H), 4.79-4.95 (m, 1 H); trace metals analysis (ICP-OES): all trace metals<10 ppm; silicon content (ICP-OES): 120 ppm.

Exemplary Embodiment 2: WO(OR)₄ where R=C₃H₆OCH₃; 4.0 eq. CH₃OC₃H₆OH; yellow oil, 81% yield

¹H-NMR (CDCl₃, 600 MHz, 300 K)δ(ppm)=1.23-1.27 (m, 12 H, CHCH3) 3.38-3.43 (m, 20 H, OCH2+OCH3), 4.74-4.83 (m, 4 H, CH); trace metals analysis (ICP-OES): all trace metals<10 ppm; silicon content (ICP-OES): 860 ppm.

Exemplary Embodiment 3: WO(OR)₄ where R=C₃H₆OC₃H₆OC₃H₇; 4.0 eq. C₃H₇OC₃H₆OC₃H₆OH; orange-colored oil, 87% yield

¹H-NMR (CDCl₃, 600 MHz, 300 K)δ(ppm)=0.85-0.97 (m, 3 H) 1.08-1.40 (m, 7 H), 1.58 (t, J=7.08 Hz, 2 H), 3.30-4.05 (m, 7 H), 4.24-4.61 (m, 1 H), 4.67-4.93 (m, 1 H); trace metals analysis (ICP-OES): all trace metals <10 ppm, silicon content (ICP-OES): 3500 ppm.

### Exemplary Embodiment 4-7: General Procedure

Reaction of WCl₆ with (TMS)₂O, ROH and NH_{3(g)} or Et₂NH in heptane with reaction step b)

WCl₆ (50.832 g; 128.17 mmol) is weighed into flasks and dissolved/suspended in 300 mL heptane (abs. or EMSURE). In a separate dropping funnel, 20.875 g (128.17 mmol, stoichiometric) of hexamethyldisiloxane are weighed in and diluted with heptane to give a 50 vol % solution. The hexamethyldisiloxane solution is metered in slowly over 30 min with stirring at an internal temperature of 19-30° C. After metering is complete, the reaction mixture is subsequently stirred for 3 hours. The color of the reaction solution changes from dark red-violet to orange-yellow.

After the end of the stirring time, a distillation bridge with a scaled 250 mL Schlenk tube is attached. The pressure is carefully reduced to 170 mbar, and the temperature of the reaction mixture is slowly increased to 40° C. First distillate is obtained starting from a top temperature of 34-36° C. The distillation is continued at 170 mbar/40° C. until no more distillate is collected in the Schlenk flask and the top temperature of the distillation apparatus decreases from 38° C. to below 34° C. The pressure is then lowered slowly in 10 mbar-steps to 160 mbar, 150 mbar and 140 mbar, and in each case distillation is carried out until no more distillate is collected and the top temperature falls below 34° C. Finally, the pressure is reduced to 120 mbar (boiling point of heptane at 40° C.) and a drag distillation is carried out. In the method, a volume of heptane twice that of the previously collected distillate is additionally distilled off. After the distillation has ended, the distillation apparatus is removed again and exchanged for a dropping funnel. The distillate is discarded.

To the reaction suspension are added 512.67 mmol of the corresponding alcohol or glycol ether (4.0 equivalents) dropwise at 0° C., with stirring, over a period of 30 min. The reaction mixture slowly changes color to a clear colorless or yellow solution.

After the end of the metering, the reaction solution is cooled to 15° C., and the feed temperature is set to 0° C. (with base=Et₂NH to 5° C.). The base is added in accordance with procedure a) or b):

a) A gas introduction pipe is placed on the apparatus, and the gas path is initially flushed with argon or nitrogen. Inert gas is then passed through the reaction solution for 10 min to displace excess HCl. After 10 min, ammonia is slowly introduced at a temperature of 10-15° C. The gas flow is initially so strong that the ammonia introduced is completely absorbed by the reaction solution. The temperature should be within a range of 0-40° C. during the introduction. The gas introduction is terminated as soon as the temperature of the reaction mixture falls and gas is blown off through the pressure relief valve. Inert gas is then passed through the reaction mixture again for 10 min. After 10 min, ammonia is again passed through the reaction mixture in order to ensure complete reaction. The excess ammonia is then flushed from the solution by inert gas, and the colorless reaction mixture is stirred for 16 h. b) 38.02 g of diethylamine (517.80 mmol, 4.04 equivalents) are metered in slowly in the course of 1 h at 25-35° C. After metering is complete, the receiver is subsequently flushed with 20 mL of heptane, and the reaction mixture is stirred for a further 16 h at RT.

Following stirring, the reaction mixture is discharged onto a filter frit and filtered. After filtration is complete, the filter cake is washed with 3×200 mL of heptane. All volatile constituents are distilled off from the obtained filtrate in vacuo (10⁻³ mbar-1 mbar) at 40-60° C. The product obtained is then dried again for 4 h at 50-60° C. and 1×10⁻³ mbar from.

### Exemplary Embodiment 4-7: Analytical Data

Exemplary Embodiment 4: WO(OR)₄ where R=iPr; 4.0 eq. iPrOH; base=NH₃; colorless solid, 77% yield

¹H-NMR (CDCl₃, 600 MHz, 300 K)δ(ppm)=1.30 (d, 6 H), 4.79-4.95 (m, 1 H); trace metals analysis (ICP-OES): all trace metals<10 ppm; silicon content (ICP-OES): 150 ppm.

Exemplary Embodiment 5: WO(OR)₄ where R=C₃H₆OCH₃; 4.0 eq. CH₃OC₃H₆OH; base=NH₃; yellow oil, 84% yield

¹H-NMR (CDCl₃, 600 MHz, 300 K)δ(ppm)=1.23-1.27 (m, 12 H, CHCH3) 3.38-3.43 (m, 20 H, OCH2+OCH3), 4.74-4.83 (m, 4 H, CH); trace metals analysis (ICP-OES): all trace metals<10 ppm; silicon content (ICP-OES): 230 ppm.

Exemplary Embodiment 6: WO(OR)₄ where R=C₃H₆OC₃H₆OC₃H₇; 4.0 eq. C₃H₇OC₃H₆OC₃H₆OH; base=NH₃; orange-colored oil, 90% yield

¹H-NMR (CDCl₃, 600 MHz, 300 K)δ(ppm)=0.85-0.97 (m, 3 H) 1.08-1.40 (m, 7 H), 1.58 (t, J=7.08 Hz, 2 H), 3.30-4.05 (m, 7 H), 4.24-4.61 (m, 1 H), 4.67-4.93 (m, 1 H); trace metals analysis (ICP-OES): all trace metals <10 ppm, silicon content (ICP-OES): 190 ppm.

Exemplary Embodiment 7: WO(OR)₄ where R=C₃H₆OC₃H₆OC₃H₇; 4.0 eq. C₃H₇OC₃H₆OC₃H₆OH; base=Et₂NH; orange-colored oil, 86% yield

¹H-NMR (CDCl₃, 600 MHz, 300 K)δ(ppm)=0.85-0.97 (m, 3 H) 1.08-1.40 (m, 7 H), 1.58 (t, J=7.08 Hz, 2 H), 3.30-4.05 (m, 7 H), 4.24-4.61 (m, 1 H), 4.67-4.93 (m, 1 H); trace metals analysis (ICP-OES): all trace metals <10 ppm, silicon content (ICP-OES): 270 ppm.

### Exemplary Embodiments 8

Based on examples 1 to 7, the results of the following examples can be obtained by varying the alcohol and the base.

Abbreviations: NH3: ammonia, DA: diethylamine, No.: number of example
The silicon contents were always within the range of 180 to 280 ppm. Without a distillation step, the silicon contents were between 800 and 5000 ppm with comparable yields.

| | | Base | Base | Yield |
|---|---|---|---|---|
| No. | Alcohol | NH3 | DA | [%] |
| 1 | 2-Methylbutane-1-ol | | X | 91 |
| 2 | | X | | 94 |
| 3 | 3-Methylbutane-1-ol | | X | 92 |
| 4 | | X | | 90 |
| 5 | 2-Methylbutane-2-ol | | X | 93 |
| 6 | | X | | 97 |
| 7 | 3-Methylbutane-2-ol | | X | 96 |
| 8 | | X | | 97 |
| 9 | Pentane-1-ol | | X | 96 |
| 10 | | X | | 95 |
| 11 | Pentane-2-ol | | X | 83 |
| 12 | | X | | 89 |
| 13 | Pentane-3-ol | | X | 92 |
| 14 | | X | | 90 |
| 15 | 2,2-Dimethylpropane-1-ol | | X | 96 |
| 16 | | X | | 91 |
| 17 | Hexane-1-ol | | X | 88 |
| 18 | | X | | 97 |
| 19 | Hexane-2-ol | | X | 77 |
| 20 | | X | | 91 |
| 21 | Hexane-3-ol | | X | 88 |
| 22 | | X | | 94 |
| 23 | 2-Methylpentane-1-ol | | X | 88 |
| 24 | | X | | 93 |
| 25 | 3-Methylpentane-1-ol | | X | 80 |
| 26 | | X | | 93 |
| 27 | 4-Methylpentane-1-ol | | X | 84 |
| 28 | | X | | 89 |
| 29 | | | X | 84 |
| 30 | 2-Methylpentane-2-ol | X | | 96 |
| 31 | 3-Methylpentane-2-ol | | X | 81 |
| 32 | | X | | 93 |
| 33 | 4-Methylpentane-2-ol | | X | 87 |
| 34 | | X | | 95 |
| 35 | 2-Methylpentane-3-ol | | X | 82 |
| 36 | | X | | 94 |
| 37 | 3-Methylpentane-3-ol | | X | 85 |
| 38 | | X | | 93 |
| 39 | 2,2-Dimethylbutane-1-ol | | X | 85 |
| 40 | | X | | 87 |
| 41 | 2,3-Dimethylbutane-1-ol | | X | 83 |
| 42 | | X | | 92 |
| 43 | 1-Methoxyethanol | | X | 86 |
| 44 | | X | | 92 |
| 45 | 1-Ethoxyethanol | | X | 87 |
| 46 | | X | | 95 |
| 47 | 1-Methoxy-2-propanol | | X | 86 |
| 48 | | X | | 84 |
| 49 | 1-Ethoxy-2-propanol | | X | 87 |
| 50 | | X | | 96 |
| 51 | 1-Propoxy-2-propanol | | X | 86 |
| 52 | | X | | 94 |
| 53 | 1-Butoxy-2-propanol | | X | 83 |
| 54 | | X | | 93 |
| 55 | Heptane-1-ol | | X | 83 |
| 56 | | X | | 95 |
| 57 | Heptane-2-ol | | X | 88 |
| 58 | | X | | 95 |
| 59 | Heptane-3-ol | | X | 78 |
| 60 | | X | | 96 |
| 61 | 1-Decanol | | X | 89 |
| 62 | | X | | 93 |
| 63 | Ethylene glycol monopropyl ether | | X | 92 |
| 64 | | X | | 85 |
| 65 | Ethylene glycol monoisopropyl ether | | X | 91 |
| 66 | | X | | 94 |
| 67 | Ethylene glycol monobutyl ether | | X | 84 |
| 68 | | X | | 89 |
| 69 | Ethylene glycol monopentyl ether | | X | 88 |
| 70 | | X | | 94 |
| 71 | Ethylene glycol monohexyl ether | | X | 83 |
| 72 | | X | | 94 |
| 73 | Ethylene glycol monophenyl ether | | X | 88 |
| 74 | | X | | 93 |
| 75 | Diethylene glycol monomethyl ether | | X | 82 |
| 76 | | X | | 97 |
| 77 | Diethylene glycol monoethyl ether | | X | 84 |
| 78 | | X | | 94 |
| 79 | Diethylene glycol monopropyl ether | | X | 81 |
| 80 | | X | | 93 |
| 81 | Diethylene glycol monoisopropyl ether | | X | 86 |
| 82 | | X | | 93 |
| 83 | Diethylene glycol monobutyl ether | | X | 83 |
| 84 | | X | | 95 |
| 85 | Diethylene glycol monopentyl ether | | X | 88 |
| 86 | | X | | 92 |
| 87 | Diethylene glycol monohexyl ether | | X | 83 |
| 88 | | X | | 91 |
| 89 | Diethylene glycol monophenyl ether | | X | 84 |
| 90 | | X | | 89 |
| 91 | | | X | 88 |
| 92 | Diethylene glycol monobenzyl ether | X | | 93 |
| 93 | Propylene glycol monoethyl ether | | X | 81 |
| 94 | | X | | 93 |
| 95 | Propylene glycol monopropyl ether | | X | 84 |
| 96 | | X | | 94 |
| 97 | Propylene glycol monoisopropyl ether | | X | 87 |
| 98 | | X | | 91 |
| 99 | Propylene glycol monobutyl ether | | X | 87 |
| 100 | | X | | 92 |
| 101 | Propylene glycol monopentyl ether | | X | 87 |
| 102 | | X | | 93 |
| 103 | Propylene glycol monohexyl ether | | X | 81 |
| 104 | | X | | 97 |
| 105 | Propylene glycol monophenyl ether | | X | 84 |
| 106 | | X | | 94 |
| 107 | Propylene glycol monobenzyl ether | | X | 81 |
| 108 | | X | | 93 |
| 109 | Isopropylene glycol monomethyl ether | | X | 82 |
| 110 | | X | | 96 |
| 111 | Isopropylene glycol monoethyl ether | | X | 86 |
| 112 | | X | | 96 |
| 113 | Isopropylene glycol monopropyl ether | | X | 88 |
| 114 | | X | | 92 |
| 115 | Isopropylene glycol monoisopropyl ether | | X | 82 |
| 116 | | X | | 94 |
| 117 | Isopropylene glycol monobutyl ether | | X | 87 |
| 118 | | X | | 94 |
| 119 | Isopropylene glycol monopentyl ether | | X | 83 |
| 120 | | X | | 94 |
| 121 | Isopropylene glycol monohexyl ether | | X | 87 |
| 122 | | X | | 93 |
| 123 | Isopropylene glycol monophenyl ether | | X | 84 |
| 124 | | X | | 95 |
| 125 | Dipropylene glycol monopropyl ether | | X | 86 |
| 126 | | X | | 90 |
| 127 | Isopropylene glycol monobenzyl ether | | X | 87 |
| 128 | | X | | 95 |
| 129 | Dipropylene glycol monomethyl ether | | X | 89 |
| 130 | | X | | 92 |
| 131 | Ethylene glycol monobenzyl ether | | X | 82 |
| 132 | | X | | 91 |
| 133 | Tripropylene glycol monomethyl ether | | X | 85 |
| 134 | | X | | 97 |
| 135 | Dipropylene glycol monobutyl ether | | X | 84 |
| 136 | | X | | 93 |
| 137 | Tripropylene glycol monobutyl ether | | X | 86 |
| 138 | | X | | 95 |

1. A method for the preparation of oxido (tetraalkoxido) tungsten compounds according to the general formula
[W(O)(OR)₄] (I)
by means of a one-pot synthesis without isolation of the intermediate, wherein
R is selected from the group consisting of straight-chain, branched or cyclic (C5-C10) alkyl groups, a straight-chain, branched or cyclic partially or fully halogenated (C5-C10) alkyl group, an alkylene alkyl ether group (R^{E}—O)n—R^{F}, a benzyl group, a partially or fully substituted benzyl group, a mononuclear or polynuclear aryl, a partially or fully substituted mononuclear or polynuclear aryl, a mononuclear or polynuclear heteroaryl and a partially or fully substituted mononuclear or polynuclear heteroaryl,
wherein
R^{E} are selected independently of one another from the group consisting of a straight-chain, branched or cyclic (C1-C6) alkylene group and a straight-chain, branched or cyclic partially or fully halogenated (C1-C6) alkylene group,
R^{F} are selected independently of one another from the group consisting of a straight-chain, branched or cyclic (C1-C10) alkyl group, a straight-chain, branched or cyclic partially or fully halogenated (C1-C10) alkyl group, and
n=1 to 5 or 1, 2 or 3,
comprising the following steps:
a) reacting WCl₆ with hexamethyldisiloxane in an aprotic solvent in a reaction vessel,
b) removing by-products and solvents from the reaction mixture by distillation,
c) adding an alcohol ROH, wherein R is as defined above;
and
a molar ratio of WCl₆:ROH is at least 1:4, and
d) supplying at least one amine or ammonia (NH₃);
e) separating out precipitated by-products.

2. The method according to claim 1, wherein the alcohol ROH is selected from the group consisting of, sBuCH₂OH, iBuCH₂OH, (iPr)(Me)CHOH, (nPr)(Me)CHOH, (Et)₂CHOH, (Et)(Me)₂COH, C₆H₁₁OH, C₆H₅CH₂OH and C₆H₅OH or the alcohol ROH is a glycol ether.

3. The method according to claim 1, wherein the by-products removed by distillation contain at least in part silicon, in particular at least in part (CH₃)₃SiCl.

4. The method according to claim 1, wherein the removal of solvent and by-products by distillation can take place completely or partially.

5. The method according to claim 2, wherein the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether.

6. The method according to claim 2, wherein the glycol ether is selected from the group consisting of selected from the group consisting of methyl glycol CH₃—O—CH₂CH₂—OH, ethoxyethanol CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH and iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH or the isomer mixtures thereof, 1-methoxy-2-propanol CH₃OCH₂CH₂CH₂OH or the isomer mixtures thereof, tripropylene glycol monomethyl ether
CH₃OCH₂CH₂CH₂OCH₂CH₂CH₂OCH₂CH₂CH₂OH or the isomer mixtures thereof, dipropylene glycol monobutyl ether C₄H₉OCH₂CH₂CH₂OCH₂CH₂CH₂OH or the isomer mixtures thereof, 1-butoxy-2-propanol C₄H₉OCH₂CH₂CH₂OH or the isomer mixtures thereof, tripropylene glycol monobutyl ether C₄H₉OCH₂CH₂CH₂OCH₂CH₂CH₂OCH₂CH₂CH₂OH or the isomer mixtures thereof, 1-propoxy-2-propanol C₃H₇OCH₂CH₂CH₂OH or the isomer mixtures thereof, the isomer mixtures thereof and the mixtures thereof.

7. The method according to claim 1, wherein the aprotic solvent is selected from the group consisting of aliphatic hydrocarbons, benzene derivatives and halogenated hydrocarbons.

8. The method according to claim 1, wherein in step a) the reaction of WCl₆ with hexamethyldisiloxane in the aprotic solvent in the reaction vessel comprises the following steps:
i) providing a solution or suspension of WCl₆ in the aprotic solvent,
ii) adding hexamethyldisiloxane,
wherein during the addition and/or after the addition of hexamethyldisiloxane, a reaction of WCl₆ with hexamethyldisiloxane takes place.

9. The method according to claim 1, wherein the reaction of WCl₆ with hexamethyldisiloxane in the aprotic solvent is carried out at an internal temperature T_{U} of the reaction vessel, the internal temperature T_{U} being between 0° C. and 150° C., in particular 10° C. to 140° C.

10. The method according to claim 1, wherein the molar ratio of WCl₆:ROH is between 1:4 and 1:40.

11. The method according to claim 1, wherein an internal temperature T_{C} of the reaction vessel during the addition and/or after the addition of the alcohol ROH is between −30° C. and 50° C.

12. The method according to claim 1, wherein an internal temperature T_{N} of the reaction vessel during the introduction and/or after the introduction of NH₃ gas is between −30° C. and 100° C.

13. The method according to claim 12, wherein
an internal temperature T_{N1} of the reaction vessel during a first phase of the introduction of NH₃ gas is between −30° C. and 20° C.
and
internal temperature T_{N2} of the reaction vessel during a second phase and/or after the second phase of the introduction of NH₃ gas is between 21° C. and 100° C.

14. The method according to claim 1, wherein, after step e), a step f) is carried out, which comprises isolating [W(O)(OR)₄].
